(19) United States
(12) Patent Application Publication
(10) Pub. No.: US 2009/0213759 A1
(43) Pub. Date: Aug. 27, 2009

(54) METHOD OF PRODUCING A NETWORK TOPOLOGY

(76) Inventor: KATSUYA KITAJIMA, Tokyo (JP)

Correspondence Address: NEC CORPORATION OF AMERICA, 6535 N. STATE HWY 161, IRVING, TX, 75039, US

(21) Appl. No.: 12/050,264

(22) Filed: Mar. 18, 2008

(30) Foreign Application Priority Data
Mar. 27, 2007 (JP) 2007-080533

(51) Int. Cl. H04L 12/28

(52) U.S. Cl. 370/254

(57) ABSTRACT

Upon producing a topology of a network including a plurality of nodes (L2SW-1 to L2SW-7) connected via the Ethernet, an NSM (101) collects, from each of the nodes, reception result information obtained by continuity check performed by each node, VLAN setting information, and MAC information of a port or ports, and produces the topology of the network for each of VLAN A and VLAN B.

This application is based upon and claims the benefit of priority from Japanese patent application No. 2007-080533, filed on Mar. 27, 2007, the disclosure of which is incorporated herein in its entirety by reference.

### BACKGROUND OF THE INVENTION

This invention relates to a network topology producing method of producing a network topology, a network management system for producing a network topology, and a recording medium which records a program for establishing the network management system by a computer.

Development has been made of a network topology producing method of producing a network topology as disclosed in, for example, Japanese Unexamined Patent Application Publication (JP-A) No. 2005-507575 (Patent Document 1), Japanese Unexamined Patent Application Publication (JP-A) No. 2006-19866 (Patent Document 2), WO 99/41889 A1 (Patent Document 3), Japanese Unexamined Patent Application Publication (JP-A) No. 2005-295209 (Patent Document 4), and Japanese Unexamined Patent Application Publication (JP-A) No. 2005-328318 (Patent Document 5).

For example, in a layer 2 (L2) network comprising the Ethernet (Registered Trademark) only, a network topology can not be produced exclusively by information held by nodes. In order to produce the network topology, it is necessary to use connection information at the time of installation work and an IP (Internet Protocol) Ping function as a layer 3 (L3) function in addition to the information held by the nodes and to consider various factors in a comprehensive manner.

In the above-mentioned method, the connection information at the time of installation work is required. This results in a problem that, without additional information such as the information about the installation work, the network topology can not be produced.

Since the additional information other than the information held by the nodes is required, it is impossible to automatically produce the network topology by an NMS (network management system).

On the other hand, Patent Document 1 discloses the invention of detecting a network topology. The disclosed invention is for use in a SDH (Synchronous Digital Hierarchy)/WDM (Wavelength Division Multiplex) system. SDH/WDM is a technique for providing a point-to-point system and has, as a standard, a function of checking continuity of section/path such as J0/J1. In order to produce the network topology by the use of the function, a large amount of information about connection between adjacent nodes is required.

Patent Document 2 also discloses the invention of detecting a network topology. In FIG. 25 of Patent Document 2, Port-MAC (Media Access Control) address information is acquired by the use of special frames illustrated in FIGS. 23 and 24. In case where a plurality of nodes are connected to the network, information of the nodes is used also. Thus, in order to produce the network topology, a large quantity of information about connection between adjacent nodes is required.

### SUMMARY OF THE INVENTION

It is therefore an exemplary object of this invention to enable network topology information to be produced only by the use of information of nodes connected to a network.

According to an exemplary aspect of this invention, there is provided a network topology producing method of producing a topology of a network comprising a plurality of nodes connected via the Ethernet, the method comprising the step in which a network management system collects, from each of the nodes, reception result information obtained by continuity check performed by each node, VLAN setting information, and MAC information of a port or ports to produce the topology of the network.

According to another exemplary aspect of this invention, there is provided a network management system for use upon producing a topology of a network comprising a plurality of nodes connected via the Ethernet, the system comprising:

information receiving means for receiving, from each of the nodes, reception result information obtained by continuity check, VLAN setting information, and MAC information of a port or ports;

memory means for memorizing the reception result information, the VLAN setting information, and the MAC information of the port or the ports which are received by the information receiving means; and

topology producing means for producing the topology of the network with reference to the reception result information, the VLAN setting information, and the MAC information of the port which are memorized in the memory means.

According to still another exemplary aspect of this invention, there is provided a recording medium which records a program for making a computer execute, upon producing a topology of a network comprising a plurality of nodes connected via the Ethernet, the steps of:

receiving, from each of the nodes, reception result information obtained by continuity check, VLAN setting information, and MAC information of a port or ports;

memorizing, in memory means, the reception result information, the VLAN setting information, and the MAC information of the port or the ports which are received in the above-mentioned step; and

producing the topology of the network with reference to the reception result information, the VLAN setting information, and the MAC information of the port or the ports which are memorized in the memory means.

In accordance with the exemplary aspects of this invention, it is possible to enable network topology information to be produced only by the use of information of nodes connected to a network.

### BRIEF DESCRIPTION OF THE DRAWING

FIG. 1 shows a structure of a network system for use with a network topology producing method according to an exemplary embodiment of this invention;

FIG. 2 is a view for describing an operation of continuity check in the exemplary embodiment of this invention; and

FIGS. 3 to 7 are views for describing a network topology producing process in the exemplary embodiment of this invention.

### DESCRIPTION OF THE EXEMPLARY EMBODIMENTS

Now, description will be made of a network topology producing method according to an exemplary embodiment of this invention, a network management system for carrying out network topology producing method, and a recording medium which records a network topology producing program for executing network topology producing method.

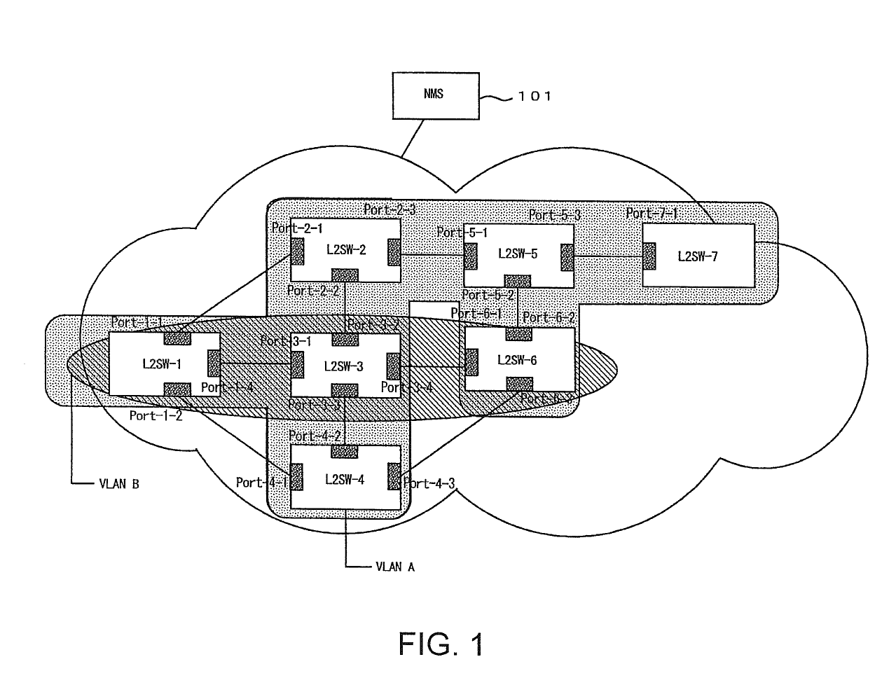

FIG. 1 shows a structure of a network system for use with the network topology producing method according to the exemplary embodiment of this invention.

A network illustrated in the figure is a layer 2 (L2) Ethernet and comprises a plurality of (seven in this exemplary embodiment) L2SW nodes (L2SW1 to L2SW-7) and a network management system (NMS) 101.

The NMS 101 may be implemented by a computer which has a memory unit, a program stored in the memory unit, and a central processing unit (CPU) for executing the program to produce a network topology which will later be described.

The NMS 101 has an information receiving unit for receiving information supplied from each node and required to produce the network topology. The memory unit memorizes the information received by the information receiving unit. The information is used when the CPU produces the network topology. Herein, the CPU forms a topology producing unit.

Each L2SW node is a layer 2 switch (SW) and has a plurality of Ethernet ports. Each L2SW node is connected to adjacent L2SW nodes via the Ethernet.

It is assumed here that, in the L2 network, two VLANs (virtual LANs (Local Area Networks) including VLAN A and VLAN B are formed.

For all Ethernet sections connecting the L2SW nodes to each other, continuity check is carried out. The details thereof will be described later.

It is assumed that the NMS 101 can access to each L2SW node and acquire information held by the L2SW node.

At first, general description will be made. The network topology producing method according to the exemplary embodiment of this invention is characterized in that, in the layer 2 Ethernet network using an Ethernet OAM (Operation Administration and Maintenance) function, the network topology can be produced only by collection of information from each device (node).

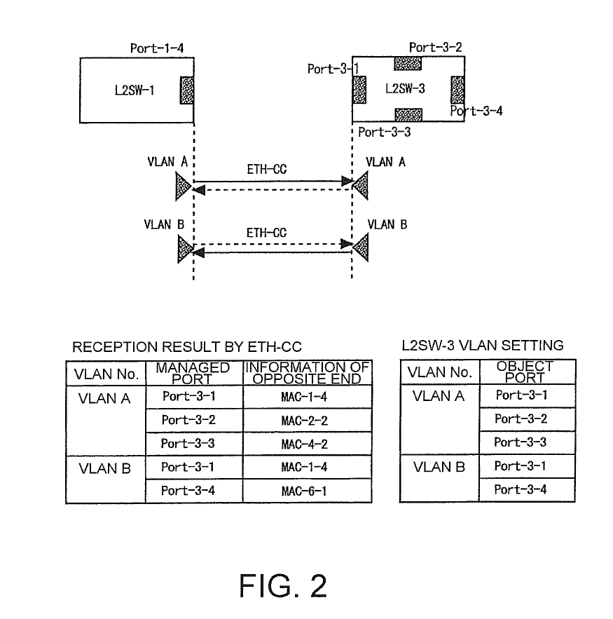

FIG. 2 shows an operation of the continuity check for acquiring the information of the Ethernet connecting the L2SW nodes to each other. As a result of the continuity check, the node L2SW-3 acquires a “reception result by ETH-CC” illustrated in FIG. 2.

Thus, in this exemplary embodiment, each L2SW node executes the continuity check to obtain connection information of the Ethernet. In addition, the NMS 101 collects information of all the L2SW nodes. Therefore, only by the information from the L2SW nodes, the NMS 101 can automatically produce the network topology.

Next, description will be made of the network topology producing method according to the exemplary embodiment of this invention by the use of the network having the above-mentioned structure.

At first, description will be made of the continuity check for acquiring information of the Ethernet connecting the L2SW nodes to each other. By way of example, an operation among the nodes L2SW-1 to L2SW-3 will be described with reference to FIG. 2.

A port-1-4 of the node L2SW-1 is connected to a port-3-1 of the node L2SW-3. From each of these opposite ends towards the other end, ETH-CC (Ethernet-Continuity Check) is performed per VLAN.

The ETH-CC function is to detect failure by transmitting and receiving test frames between the devices (nodes) and is defined by ITU-T Y.1731 (Ethernet (Registered Trademark) OAM). Therefore, description of the operation of ETH-CC is omitted herein.

As a result of the continuity check, the node L2SW-3 obtains the “reception result by ETH-CC” illustrated in FIG. 2.

The node L2SW-3 has VLAN setting information as illustrated in a table entitled “L2SW-3 VLAN setting” in FIG. 2. Thus, the VLAN setting information can be acquired from the node L2SW-3.

Next, description will be made of an operation of actually producing an Ethernet topology with respect to the VLAN B.

At first, the NMS 101 collects, from each of the L2SW nodes of the network managed by the NMS 101, (1) the reception result by ETH-CC, (2) the VLAN setting information, and (3) MAC (Media Access Control) information of a port or ports and searches information related to the VLAN B. At this time, the receiving unit in the NMS 101 receives each information from each L2SW node and the memory unit in the NMS 101 memorizes the information.

The NMS 101 collects the continuity check information, the VLAN information, the MAC information of the port or the ports, and so on held by each L2SW node by the use of a known communication method (for example, SNMP (Simple Network Management Protocol), TL1 (Transaction Language One)).

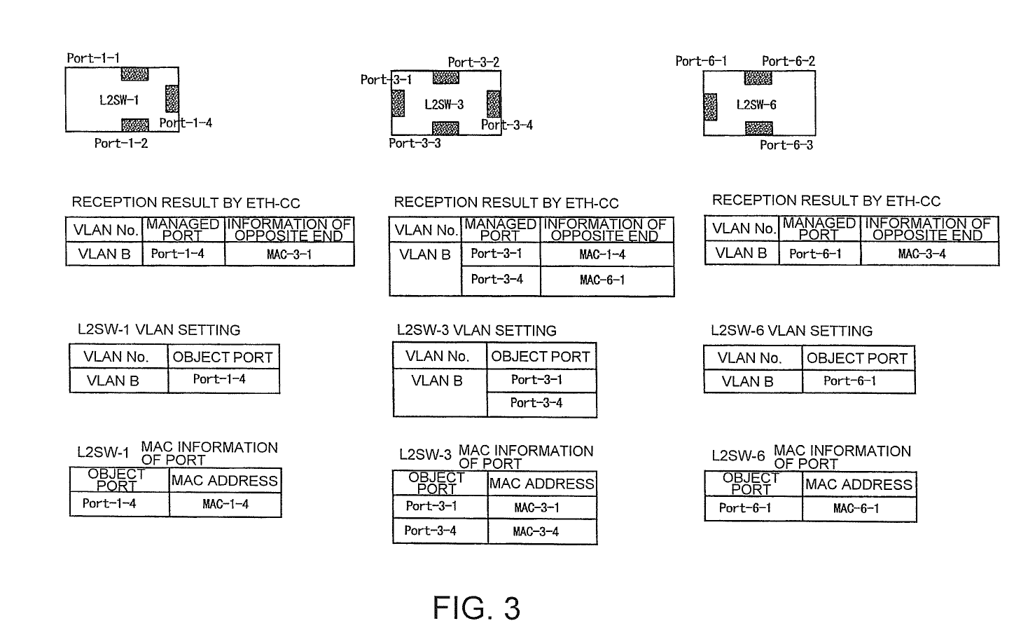

FIG. 3 shows the result, including information of the L2SW nodes in relation to the VLAN B and VLAN B-related information obtained from each L2SW node.

In this state, only the information of the L2SW nodes is obtained without connection therebetween. Thus, no topology information is obtained.

The NMS 101 uses, among the information collected as mentioned above, (1) the reception result by ETH-CC and (3) the MAC information of the port or the ports and produces connection between the L2SW nodes.

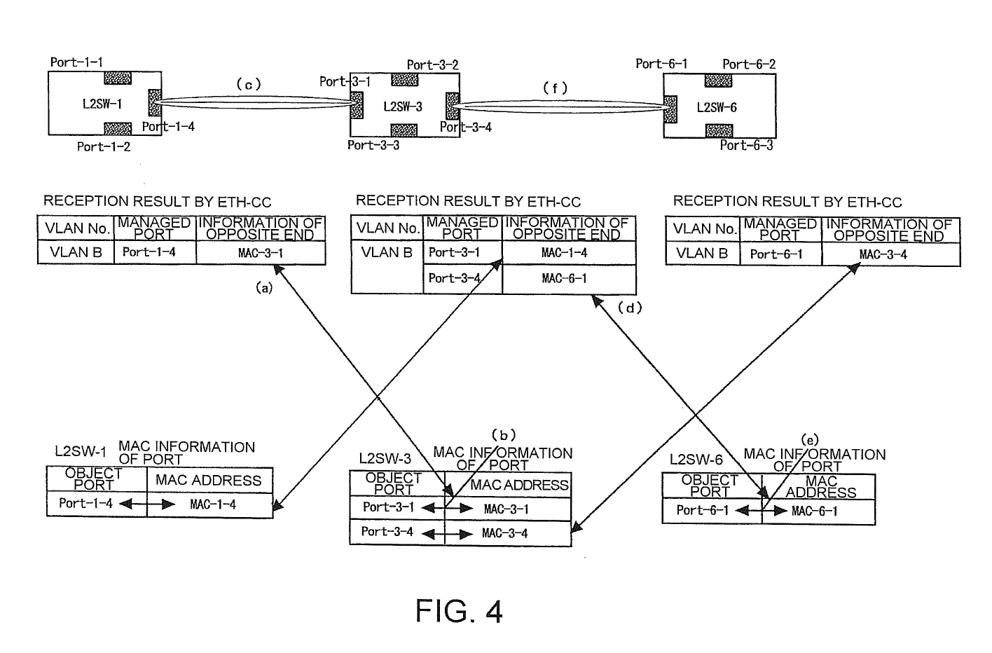

Referring to FIG. 4, the operation will be described. For example, from the result by ETH-CC of the node L2SW-1, the port-1-4 is connected to the port-3-1 having MAC-3-1. Then, as regards the port-3-1 having MAC-3-1, (3) the MAC information of the port is searched. As a result, it is detected that the port-3-1 is in the node L2SW-3 (a).

From the MAC information of the ports in the node L2SW3, it is understood that the MAC-3-1 corresponds to the port-3-1 (b). From the information (a) and (b), it is known that the port-1-4 of the node L2SW-1 is connected to the port-3-1 of the node L2SW-3 (c).

Similarly, the information (f) is obtained from (d) and (e).

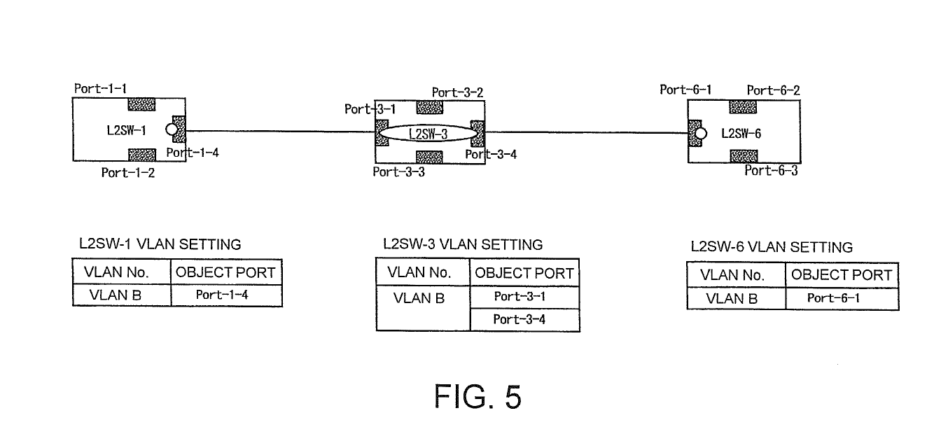

On the other hand, from the state of VLAN setting of each L2SW node, the state of port connection in each L2SW node is known as shown in FIG. 5.

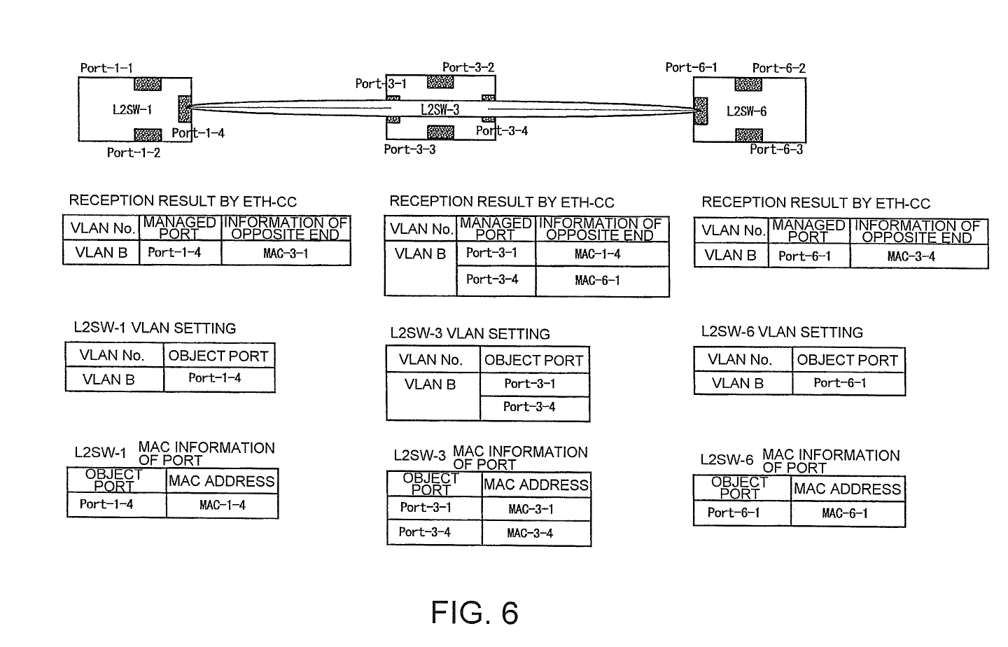

By combining the connection information between the L2SW nodes (FIG. 4) and the connection information in each L2SW node (FIG. 5), the network topology of the VLAN B can be produced as shown in FIG. 6.

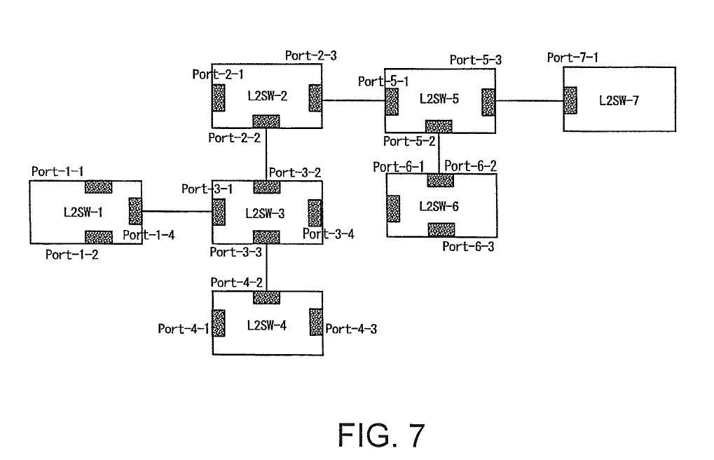

By executing the similar operation for the VLAN A, the network topology of the VLAN A can be produced as shown in FIG. 7.

In the conventional L2 Ethernet network, there is no means for acquiring the network topology from the information of each device (node). By the use of the information at the time of installation work, the setting information, the L3 Ping function, and so on, the topology information is manually produced. Therefore, with the L2 function alone, the network topology of the L2 Ethernet can not be produced.

On the other hand, in this exemplary embodiment, it is possible to produce the network topology of the L2 Ethernet with respect to each VLAN only by two kinds of information, i.e., (1) by acquiring connection information between adjacent nodes for each VLAN by executing the continuity check between adjacent nodes for each VLAN and (2) by acquiring VLAN setting information in each L2SW node.

Since the connection information is known from the information of the L2SW nodes by the use of a presented program, the network topology can be produced only by the information from the L2SW nodes.

Since the network topology can be produced only by the information from the L2SW nodes, the network topology can be automatically produced without using the installation information such as the connection information.

Furthermore, the network topology can be produced with the minimum essential amount of information.

The L2SW network is a technique for providing a multipoint-to-multipoint system. There is no technique corresponding to J0/J1 of the SDH (Synchronous Digital Hierarchy)/WDM (Wavelength Division Multiplexing). Therefore, this invention is different in use environment and conditions from the conventional network topology producing method described above.

In the foregoing exemplary embodiment, the continuity check is executed for each VLAN. As another exemplary embodiment of this invention, this invention may be extended to the case where a physical network topology is produced. The physical network topology can be substantially produced by using the information for all ports, not for each VLAN.

This invention is applicable to a method of producing a topology of a network comprising various apparatuses as nodes connected via the Ethernet.

Summarizing, various exemplary aspects of this invention are as follows:

(1) A network topology producing method of producing a topology of a network comprising a plurality of nodes connected via the Ethernet, the method comprising the step in which a network management system collects, from each of the nodes, reception result information obtained by continuity check performed by each node, VLAN setting information, and MAC information of a port or ports to produce the topology of the network.

The network management system collects, from each node, the reception result information obtained by the continuity check carried out by each node, the VLAN setting information, and the MAC information of the port or the ports to produce the topology of the network.

(2) The method according to (1), wherein the network management system produces connection information about connection between the nodes by the use of the reception result information obtained by the continuity check and the MAC information of the port or the ports, detects a port connection state in each node with reference to the VLAN setting information to produce port connection information in each node, and produces the topology of the network with reference to the connection information between the nodes and the connection information in each node.

(3) The method according to (1) or (2), wherein the network is a layer 2 Ethernet using an Ethernet OAM function.

(4) The method according to any one of (1), (2), and (3), wherein the network includes a plurality of VLANs and the management system produces the topology of the network for each VLAN.

(5) A network management system for use upon producing a topology of a network comprising a plurality of nodes connected via the Ethernet, the system comprising:

information receiving means for receiving, from each of the nodes, reception result information obtained by continuity check, VLAN setting information, and MAC information of a port or ports;

memory means for memorizing the reception result information, the VLAN setting information, and the MAC information of the port or the ports which are received by the information receiving means; and

topology producing means for producing the topology of the network with reference to the reception result information, the VLAN setting information, and the MAC information of the port which are memorized in the memory means.

The information receiving means receives, from each node, the reception result information obtained by the continuity check, the VLAN setting information, and the MAC information of the port or the ports. The memory means memorizes the reception result information, the VLAN setting information, and the MAC information of the port, which are received by the information receiving means. The topology producing means produces the topology of the network with reference to the reception result information, the VLAN setting information, and the MAC information of the port or the ports, which are memorized in the memory means.

(6) The network management system according to (5), wherein the topology producing means produces connection information about connection between the nodes by the use of the reception result information and the MAC information of the port or the ports, detects a port connection state in each node with reference to the VLAN setting information to produce port connection information in each node, and produces the topology of the network with reference to the connection information between the nodes and the connection information in each node.

(7) The network management system according to (5) or (6), wherein the network is a layer 2 Ethernet using an Ethernet OAM function.

(8) The network management system according to any one of (5), (6), and (7), wherein the network includes a plurality of VLANs and the topology producing means produces the topology of the network for each VLAN.

(9) A recording medium which records a program for making a computer execute, upon producing a topology of a network comprising a plurality of nodes connected via the Ethernet, the steps of:

receiving, from each of the nodes, reception result information obtained by continuity check, VLAN setting information, and MAC information of a port or ports;

memorizing, in memory means, the reception result information, the VLAN setting information, and the MAC information of the port or the ports which are received in the above-mentioned step; and

producing the topology of the network with reference to the reception result information, the VLAN setting information, and the MAC information of the port or the ports which are memorized in the memory means.

When the computer executes the program to produce the topology of the network comprising a plurality of nodes connected by the Ethernet, the computer executes the steps of:

receiving, from each of the nodes, reception result information obtained by continuity check, VLAN setting information, and MAC information of a port or ports;

memorizing, in memory means, the reception result information, the VLAN setting information, and the MAC information of the port or the ports which are received in the above-mentioned step; and

producing the topology of the network with reference to the reception result information, the VLAN setting information, and the MAC information of the port or the ports which are memorized in the memory means.

(10) The recording medium according to (9), wherein the program makes the computer execute the steps of:

producing connection information about connection between the nodes by the use of the reception result information and the MAC information of the port or the ports;

detecting a port connection state in each node with reference to the VLAN setting information to produce port connection information in each node; and

producing the topology of the network with reference to the connection information between the nodes and the connection information in each node.

(11) The recording medium according to (9) or (10), wherein the network is a layer 2 Ethernet using an Ethernet OAM function.

(12) The recording medium according to any one of (9), (10), and (11), wherein:

the network includes a plurality of VLANs;

the program makes the computer execute the step of producing the topology of the network for each VLAN.

While the invention has been particularly shown and described with reference to exemplary embodiments thereof, the invention is not limited to these embodiments. It will be understood by those of ordinary skill in the art that various changes in form and details may be made therein without departing from the sprit and scope of this invention as defined by the claims.

What is claimed is:

1. A network topology producing method of producing a topology of a network comprising a plurality of nodes connected via the Ethernet, the method comprising the step in which a network management system collects, from each of the nodes, reception result information obtained by continuity check performed by each node, VLAN setting information, and MAC information of a port or ports to produce the topology of the network.

2. The method according to claim 1, wherein the network management system produces connection information about connection between the nodes by the use of the reception result information obtained by the continuity check and the MAC information of the port or the ports, detects a port connection state in each node with reference to the VLAN setting information to produce port connection information in each node, and produces the topology of the network with reference to the connection information between the nodes and the connection information in each node.

3. The method according to claim 1, wherein the network is a layer 2 Ethernet using an Ethernet OAM function.

4. The method according to claim 1, wherein the network includes a plurality of VLANs and the management system produces the topology of the network for each VLAN.

5. A network management system for use upon producing a topology of a network comprising a plurality of nodes connected via the Ethernet, the system comprising:
information receiving means for receiving, from each of the nodes, reception result information obtained by continuity check, VLAN setting information, and MAC information of a port or ports;
memory means for memorizing the reception result information, the VLAN setting information, and the MAC information of the port or the ports which are received by the information receiving means; and
topology producing means for producing the topology of the network with reference to the reception result information, the VLAN setting information, and the MAC information of the port which are memorized in the memory means.

6. The network management system according to claim 5, wherein the topology producing means produces connection information about connection between the nodes by the use of the reception result information and the MAC information of the port or the ports, detects a port connection state in each node with reference to the VLAN setting information to produce port connection information in each node, and produces the topology of the network with reference to the connection information between the nodes and the connection information in each node.

7. The network management system according to claim 5, wherein the network is a layer 2 Ethernet using an Ethernet OAM function.

8. The network management system according to claim 5, wherein the network includes a plurality of VLANs and the topology producing means produces the topology of the network for each VLAN.

9. A recording medium which records a program for making a computer execute, upon producing a topology of a network comprising a plurality of nodes connected via the Ethernet, the steps of:
receiving, from each of the nodes, reception result information obtained by continuity check, VLAN setting information, and MAC information of a port or ports;
memorizing, in memory means, the reception result information, the VLAN setting information, and the MAC information of the port or the ports which are received in the above-mentioned step; and
producing the topology of the network with reference to the reception result information, the VLAN setting information, and the MAC information of the port or the ports which are memorized in the memory means.

10. The recording medium according to claim 9, wherein the program makes the computer execute the steps of:
producing connection information about connection between the nodes by the use of the reception result information and the MAC information of the port or the ports;
detecting a port connection state in each node with reference to the VLAN setting information to produce port connection information in each node; and
producing the topology of the network with reference to the connection information between the nodes and the connection information in each node.

11. The recording medium according to claim 9, wherein the network is a layer 2 Ethernet using an Ethernet OAM function.

12. The recording medium according to claim 9, wherein:
the network includes a plurality of VLANs;
the program makes the computer execute the step of producing the topology of the network for each VLAN.
